(19) United States
(12) Patent Application Publication
(10) Pub. No.: US 2005/0251804 A1
(43) Pub. Date: Nov. 10, 2005

(54) Method, data processing system, and computer program product for detecting shared resource usage violations

(75) Inventors: Thomas Edward Musta, Rochester, MN (US); Darrell Christopher Reimer, Tarrytown, NY (US); David Alan Zavala, Rochester, MN (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/838,491

(22) Filed: May 4, 2004

(51) Int. Cl. G06F 9/46

(52) U.S. Cl. 718/100

(57) ABSTRACT

A method, computer program product, and a data processing system for identifying a shared resource usage violation in a data processing system is provided. A set of resources are assigned to a resource group. A usage policy is defined that is associated with the resource group. A usage state associated with a resource of the resource group is compared with a threshold defined by a policy associated with the resource group. A determination is made if usage of the resource is in violation of the policy.

### BACKGROUND OF THE INVENTION

1. Technical Field

The present invention relates generally to an improved data processing system and in particular to a method and computer program product for detecting shared resource usage violations in a data processing system. Still more particularly, the present invention provides a method and computer program product for monitoring shared resources in a data processing system and for reporting violations of such resources.

2. Description of Related Art

Managed computing environments are inherently complex. Hundreds of concurrent tasks requiring access to shared system resources may be executed concurrently. As the complexity of the tasks increases, the reliability of the managed computing environment may be degraded. The condition where a task utilizes more or less of an expected measure of system resources may often indicate that an application or operating system failure has occurred or is eminent. The detection of such conditions is crucial for operators to properly diagnose problematic tasks while the system resources are still active and thus identifiable.

Thus, it would be advantageous to provide a monitor to detect and report a shared resource that exhibits unexpected usage behavior during execution of a task. It would be further advantageous to provide a monitor mechanism for identifying shared resource usage violations in a manner that is scalable. It would further be advantageous to provide a shared resource usage violation detection system that is adapted to identify hung threads in a data processing system.

### SUMMARY OF THE INVENTION

The present invention provides a method, computer program product, and a data processing system for identifying a shared resource usage violation in a data processing system. A set of resources are assigned to a resource group. A usage policy is defined that is associated with the resource group. A usage state of a resource included in the resource group is determined. The usage state of a resource included in the resource group is compared with a threshold defined by a policy associated with the resource group. A determination is made if usage of the resource is in violation of the policy.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server and feature a resource usage violation detection mechanism in accordance with a preferred embodiment of the present invention;

FIG. 3 is a block diagram illustrating a data processing system that may be implemented as a client of the network of FIG. 1 according to a preferred embodiment of the present invention;

FIG. 4 is a block diagram of a software architecture for implementing a shared resource usage violation detection system according to a preferred embodiment of the present invention;

FIG. 5 is a flowchart illustrating processing performed by a shared resource monitor during setup of a task dispatch in accordance with a preferred embodiment of the present invention;

FIG. 6 is a flowchart of processing performed upon completion of a work task in accordance with a preferred embodiment of the present invention;

FIG. 7 is a flowchart illustrating shared resource monitor processing for identifying resource usage violations in accordance with a preferred embodiment of the present invention;

FIG. 8 is a flowchart illustrating a self-tuning routine of the shared resource monitor implemented according to a preferred embodiment of the present invention;

FIG. 9 is diagrammatic illustration of a software component architecture for performing thread hang detection in accordance with a preferred embodiment of the present invention;

FIG. 10 is a diagrammatic illustration of an exemplary interface between components of a thread hang detection system and a thread pool in accordance with a preferred embodiment of the present invention;

FIG. 11 is a diagrammatic illustration of component interactions of a thread hang detection system and a thread pool in accordance with a preferred embodiment of the present invention;

FIG. 12 is a flowchart of processing performed by a thread hang detection system in accordance with a preferred embodiment of the present invention; and

FIG. 13 is a flowchart of object initialization for implementing thread hang detection in accordance with a preferred embodiment of the present invention.

### DETAILED DESCRIPTION OF THE PREFERRED EMBODIMENT

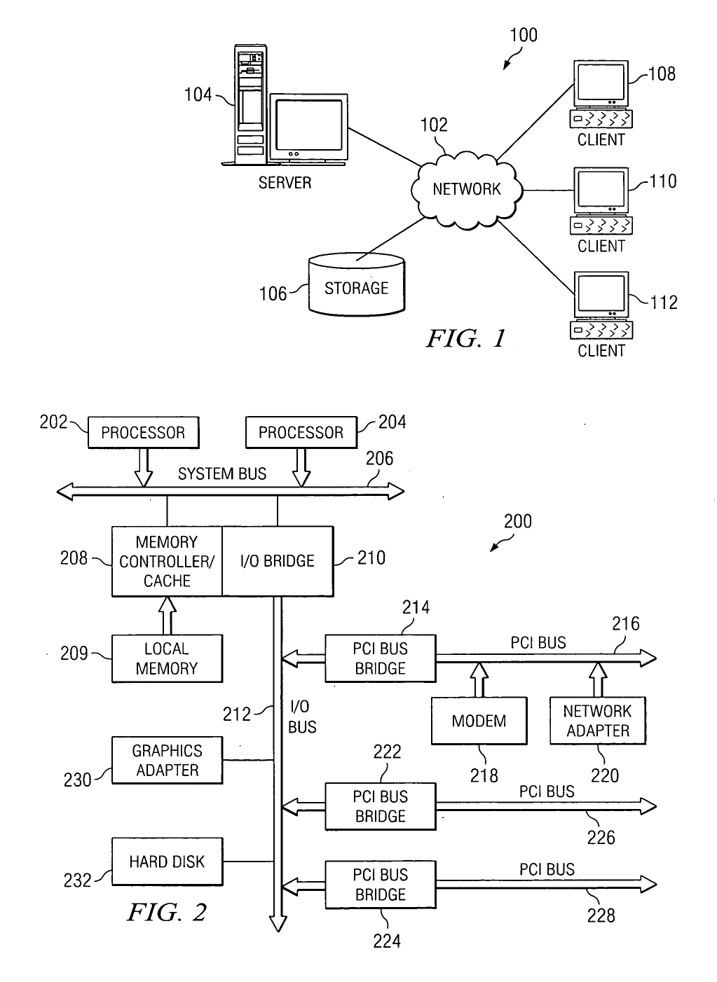

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

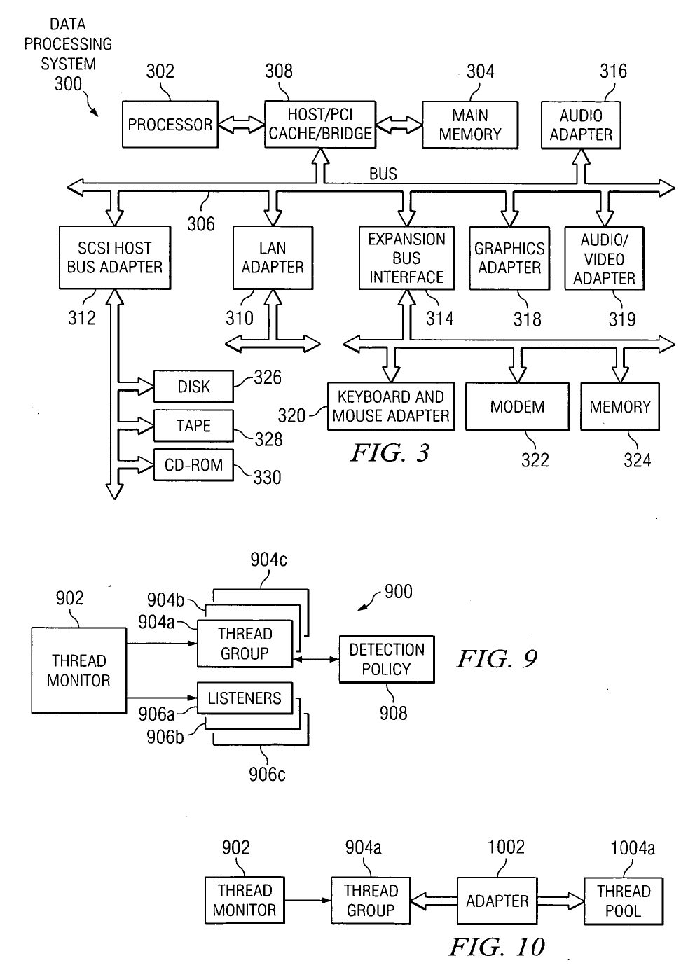

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system. The depicted example in FIG. 3 and above-described examples are not meant to imply architectural limitations.

The present invention provides a mechanism to detect a usage of a shared resource of a data processing system, such as data processing system 200 shown in FIG. 2, that violates a threshold of a predefined usage policy. The processes of the present invention are performed by a processing device such as processor 202 or 204 using computer implemented instructions, which may be located in a memory device such as local memory 209 or another suitable storage device. The computer implemented instructions are preferably integrated in a base application server software, such as the Z/OS. Accordingly, resource usage violation may be detected at runtime in accordance with the teachings of the invention.

A detected resource usage may be a calculated resource state or a measured resource state. In one particular implementation, shared resource usage detection is implemented as a mechanism for detecting hung threads, which are threads executing longer than an expected amount of time. While embodiments of the present invention are shown and described for detecting hung threads, it should be understood that the present invention is not limited to such application and may instead be employed for detecting any system resource usage that violates a predefined resource usage policy. The illustrative descriptions provided herein are intended only to facilitate an understanding of the present invention.

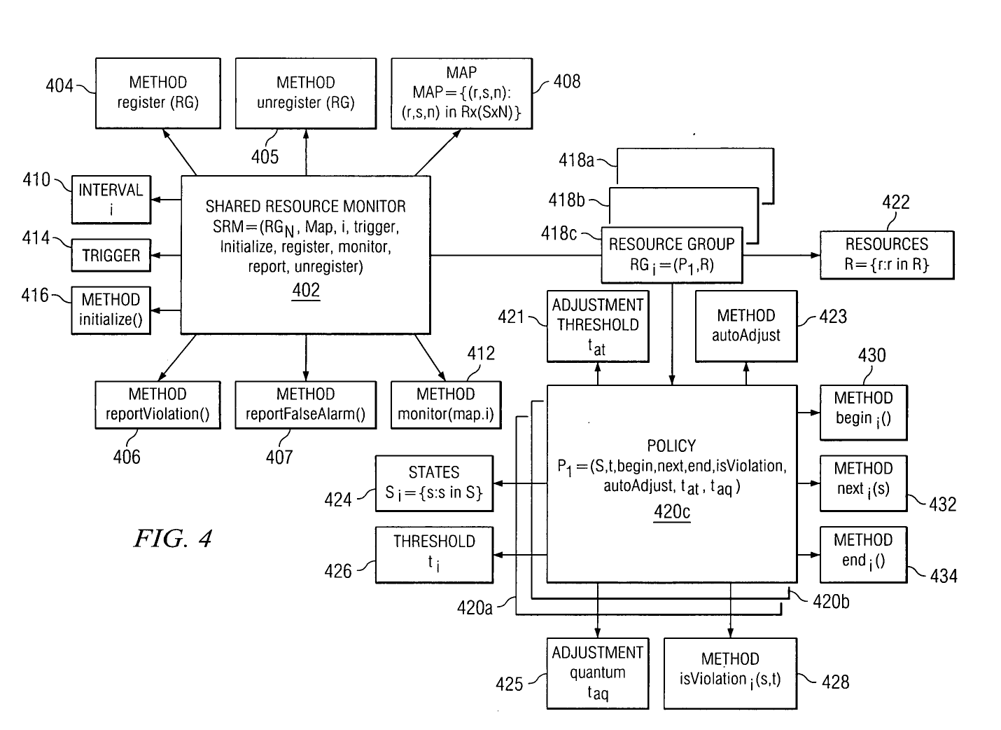

FIG. 4 is a block diagram of a software architecture for implementing a shared resource usage violation detection system according to a preferred embodiment of the present invention. Shared resource monitor (SRM) 402 provides a mechanism in these illustrative examples to monitor shared resource usage violations and may be represented as the following:
SRM(RG_{N}, map, i, trigger, initialize, register, monitor, reportViolation, reportFalseAlarm, unregister)

Shared resources (R) 422 are assumed to comprise a homogenous resource set that can be utilized during execution of a computation task. For example, shared resources R may comprise a set of thread pools, socket pools, or other entities that may be shared among multiple tasks that are executed by data processing system 200. Shared resource monitor 402 mechanism includes or interfaces with the following entities:
a number N of resource groups (RG) 418a-418c
a usage policy (P) 420a-420c each associated with a respective RG 418a-418c
a map 408
an interval(i) 410
a trigger 414
a monitor method 412
a reportViolation method 406
a reportFalseAlarm method 407
register method 404 and unregister method 405 to register and unregister resource groups with and from SRM 402
initialize method 416 to initialize the state of SRM 402

A resource group is a coupling, or association, between a disjoint subset of resources of the shared resources R and an associated usage policy. For example, a resource group RG 918a may comprise an adapter that interfaces with shared resources, such as thread pools, and the shared resource monitor. A single resource, such as a thread, socket, or other resource, assigned to a resource group is herein designated as r. Each resource group has a unique associated policy P.

A usage policy, P, may be represented by the following:

P(S, t, begin, next, end, isViolation, autoAdjust, tat, taq) and defines a set of calculable states (S) 424, a threshold (t) 426 state variable, an adjustment threshold (tat) 421 state variable, autoAdjust method 423, threshold adjustment quantum or value taq (425), begin method 430, next method 432, and end method 434, and a predicate method isViolation 428. States S represent a measure of usage for shared resources. Threshold state t is a state variable that defines a usage threshold. AutoAdjust method 423 controls a self-tuning or adjusting mechanism of SRM 402. Adjustment threshold (tat) 421 defines a maximum value used for comparison with a number of false alarms or false policy violation identifications of a particular resource usage policy. In accordance with a preferred embodiment of the present invention, identification of a number of false alarms or false policy violations that exceed adjustment threshold 421 results in adjustment of threshold 426 by threshold adjustment quantum 425. For example, work tasks that result in large numbers of resource usage policy violations may be an indication that threshold 426 is too sensitive. Adjustment threshold 421 provides a mechanism for adjusting threshold 426. Preferably, adjustment threshold 421 may be disabled so that the self-tuning functionality of SRM 402 is disabled. Methods begin, next, and end facilitate calculation of a usage state. Predicate method isViolation determines whether a state of S violates the threshold state t.

Notably, resource groups may be defined for any system resource that is desired to be monitored. Moreover, a resource group may be expanded or reduced dependent on particular system performance evaluation criteria. By defining resource groups and associated usage policies, objects that the shared resource monitor evaluates may be scaled by modifying the resource sets, e.g., by adding or removing resources of a particular resource type such as thread pools, and may be scaled by resource type, e.g., by adding socket pools, in addition to thread pools, for evaluation.

Map 408 maintains a correspondence between resources and their usage states as well as the number of violations reported. That is, map 408 contains tuples (r, (s,n)) over a set Rx(SxN), where N is the set of natural numbers.

Interval i 410 specifies the periodicity over which trigger 414 will activate. Trigger 414 invokes SRM 402 to locate shared resource policy violations.

Monitor method 412 employs map 408 and usage polices 920a-920c to locate shared resources whose calculated or measured state is in violation of a policy threshold t.

ReportViolation method 406 communicates information about shared resources that have been identified as having their associated usage policy violated. ReportFalseAlarm method 407 communicates information about shared resources that are no longer in violation of their associated usage policy.

Before monitoring data processing system 200 for shared resource violations, SRM 402 is initialized by invoking initialize method 416. Invocation of initialize method 416 results in collection of the configuration settings from the computing environment if the configuration settings are externally defined. Interval i 410 is set to the value defined by the external specifications or to a default interval. Map 408 and resource groups 418a-418c are then set to respective empty sets. A default policy, e.g., policy 420a, is obtained from the external specifications if specified. Trigger 414 is then set to interval 410 so that monitor method 412 is invoked at intervals of i.

After SRM 402 is initialized, the computing environment can register a resource group RG, e.g., RG 418a, with SRM 402 using register method 404. Registering a resource group includes registration of one or more shared resources R of data processing system 200 and a corresponding resource group policy P. Upon registration, SRM 402 can monitor any of the resources in the resource group for violation of the corresponding policy P, e.g., policy 420a.

Register method 404 is executed when no other monitor, register, or unregister methods are executing. When no monitor, register or unregister methods are executing, SRM 402 is locked for registration of a resource group.

If a policy P is not specified for the resource group, a default policy obtained during initialization of SRM 402 is set as the resource group policy. The new resource group RG is added to the resource group set RGN of SRM 402. SRM 402 is then unlocked.

A resource group, e.g., resource group 418a, may be removed from SRM 402 by invoking unregister method 405. Invocation of unregister method 405 is performed when no other monitor, register, or unregister methods are executing. SRM 402 is locked during invocation of unregister method 405. For each resource r assigned to the resource group, a corresponding record (r,(s,n)) is removed from map 408, where S designates a measure or calculated state and n designates the number of detected violations for the resource r associated with the record. The resource group is then removed from the resource group set RGN of SRM 402 and SRM 402 is then unlocked.

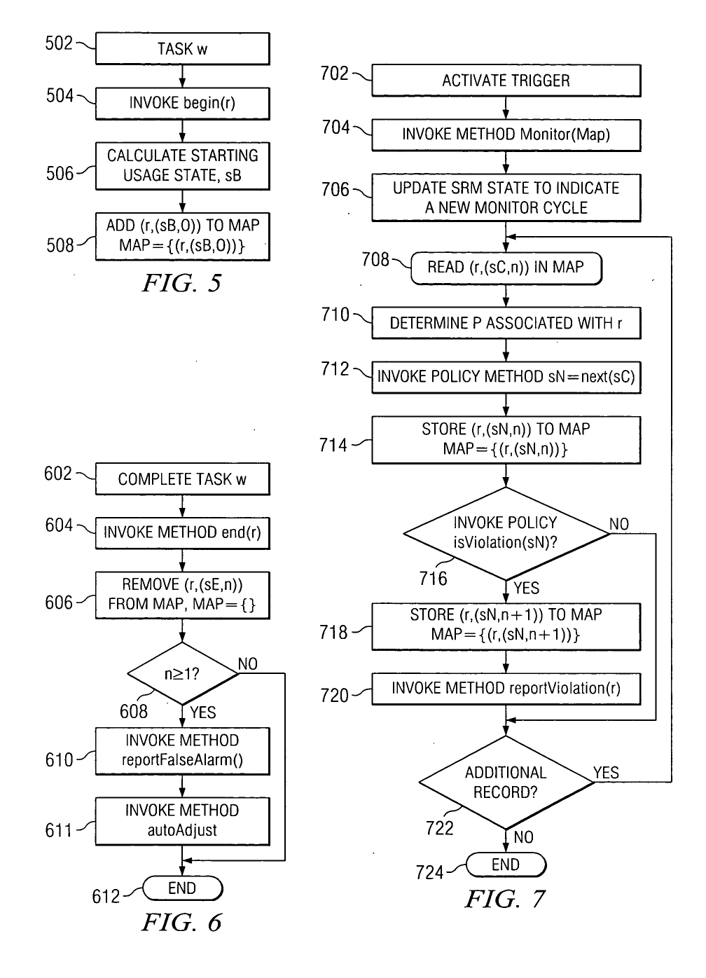

Once SRM 402 is initialized, data processing system 200 manages a set of working tasks. FIG. 5 is a flowchart illustrating processing performed by SRM 402 during setup of a task dispatch in accordance with a preferred embodiment of the present invention. Data processing system receives a directive to execute a task w (step 502). These examples assume task w utilizes a resource r, such as a thread or socket, of a resource group RG, such as resource group 418a. Prior to dispatching the operation involving usage of resource r, the task invokes begin method 430 of a policy P, e.g., policy 420a, assigned to resource group 418a (step 504). Begin method 430 calculates an initial usage state, sB, that is recorded in states 424 (step 506). For example, the usage state may be the system time sampled upon invocation of the begin method. A record (r, (sB, 0)) is inserted into map 408 that correlates the resource r and the initial usage state (sB) (step 508). Entry “0” of the record inserted into map 408 indicates no usage violations have been evaluated for the corresponding resource.

FIG. 6 is a flowchart of processing performed upon completion of a work task w in accordance with a preferred embodiment of the present invention. When the operation has completed execution (step 602), task w invokes end method 434 (step 604). The record allocated for task w is then removed from map 408 (step 606). In the illustrative example, the record allocated for task w is designated as (r,(sE, n)), where sE designates the resource usage state at the time end method 434 is executed and n designates the number of reported usage violations evaluated during execution of task w.

An evaluation of the number of usage violations recorded in the record allocated for task w is then made (step 608). If no usage violations were recorded for task w, end method 434 completes (step 612). If, however, any usage violations have been recorded for task w, reportFalseAlarm method 407 is invoked to indicate that resource r utilized during execution of task w is no longer in violation of its usage policy, and autoAdjust method 423 is subsequently invoked (step 611). Thereafter, end method 434 completes execution.

FIG. 7 is a flowchart illustrating SRM 402 processing for identifying resource usage violations in accordance with a preferred embodiment of the present invention. Concurrent with the beginning of execution of task w, trigger 414 is repeatedly executed at interval i 410 (step 702). Trigger 414, responsive to being executed, invokes monitor method 412 (step 704). A state variable env, or another suitable entity, is updated to indicate a new monitor cycle is in progress (step 706). A record (r,(sC,n)) in map 408 is then read, where sC indicates the current usage state of resource r (step 708). For the read record, a policy P associated with resource r is determined (step 710). For example, a policy association with a resource group may be maintained by a table or other data structure. Next method 432 is then invoked to obtain the next usage state sN for the shared resource r based on the current usage state sC (step 712). For example, assume usage states are time samples used for deriving the duration a resource is executed. Next method 432 may determine the next usage state by calculating the difference between the beginning usage state and the current usage state, e.g., by determining the difference between the current time and the begin time at which the resource began execution. The correlation record (r,(sN,n)) is then stored in map 408 (step 714).

Method isViolation 428 is then invoked to determine if the usage state sN is in violation of the usage policy P of resource r (step 716). If the next usage state sN does not violate the policy P of resource r, the resource violation monitoring routine proceeds to determine whether additional records remain to be evaluated (step 722). For example, if the policy associated with the resource specifies a threshold of t seconds and the resource was executed for an amount of time less than the policy threshold, the usage state sN is evaluated as not in violation of the policy. If the next usage sate sN is evaluated as a violation of the usage policy of resource r, the counter n is incremented to properly indicate the number of identified policy violations and the updated record is stored in map 408 (step 718). Method reportViolation is invoked to announce that the usage of resource r is in violation of its associated policy P (step 720).

The resource violation monitoring routine then proceeds to step 722 to determine whether additional records remain in map 408 for evaluation. If additional records remain, the routine returns to step 708 for reading the next record of map 408. Otherwise, the resource violation monitoring routine ends (step 724).

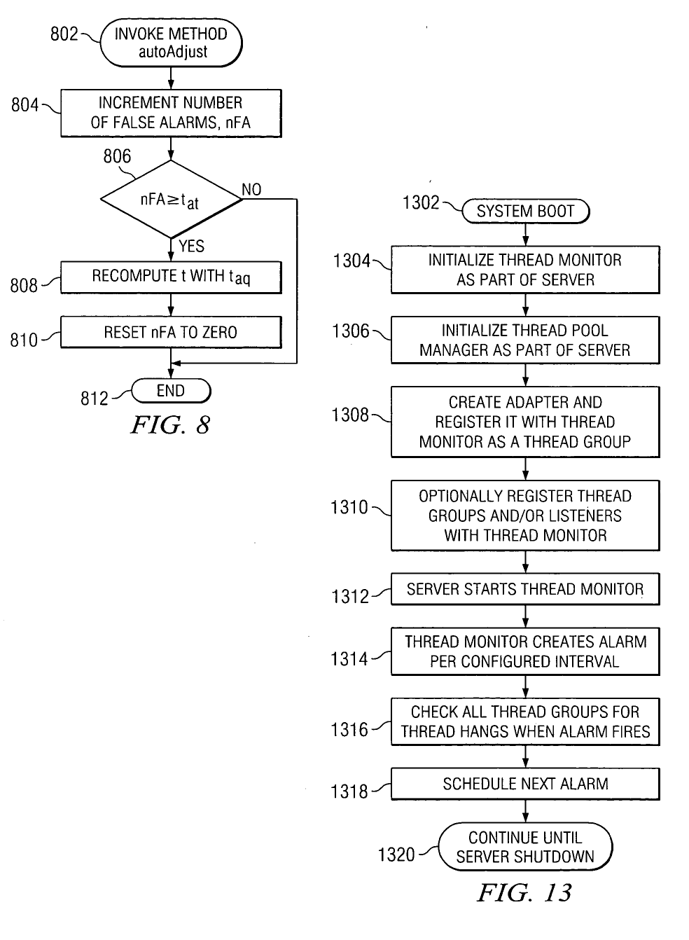

FIG. 8 is a flowchart illustrating a self-tuning routine of SRM 402 implemented according to a preferred embodiment of the present invention. Autoadjust method 423 is invoked (step 802) and a false-alarm counter variable nFA that maintains a count of the number of false alarms, or identified false violation reports, is incremented (step 804). A comparison of the counter variable nFA and adjustment threshold 421 is then made (step 806). In the event the number of false alarms is less than adjustment threshold 421, execution of autoAdjust method 423 ends (step 812). If the number of false alarms equals or exceeds adjustment threshold 421, threshold 426 is adjusted as a function of threshold adjustment quantum 425 (step 808). For example, threshold 426 may be increased or reduced as a function of threshold adjustment quantum 425. Threshold adjustment quantum may be implemented as a static value, e.g., 1.5 or another constant value. After adjustment of threshold 426, counter variable nFA is preferably reset to zero (step 810) and processing of autoAdjust method 423 then terminates according to step 812.

FIG. 9 is diagrammatic illustration of a software component architecture for performing hung thread detection in accordance with a preferred embodiment of the present invention. Hung thread detection system 900 is an exemplary implementation of the shared resource usage violation detection system describe above with reference to FIGS. 1-8. Hung thread detection system 900 includes thread monitor 902 implemented as a server runtime component. Thread monitor 902 is an exemplary implementation of SRM 402 described with reference to FIG. 4. Thread monitor 902 provides coordination of detecting hung threads and issues notifications when thread hang events are identified. Towards that end, thread monitor 902 will manage a set of thread groups 904a-904c that partition the managed threads into logical collections. Thread groups 904a-904c are exemplary implementations of resource groups 418a-418c. Each thread group 904a-904c (collectively referred to as thread groups 904) is responsible for discerning if any of its threads are hung. The definition of a hung thread is formalized via detection policy interface 908.

Different policies defined by detection policy interface 908 may be configured for different thread groups 904a-904c. Thread monitor 902 also manages a set of thread monitor listeners 906a-906c (collectively referred to as listeners 906) that are notified whenever a thread is determined to be hung. A listener may be implemented as an interface application that conveys information of a violation notification to an external application such as a debugging application, an output file that may be utilized for debugging purposes, or another entity that receives or records notifications of resource usage violations. Additionally, thread monitor listeners 906 may be notified when a previously reported hung thread has completed execution—thus providing an indication of a false hung thread report.

FIG. 10 is a diagrammatic illustration of an exemplary interface between components of thread hang detection system 900 shown in FIG. 9 and a thread pool in accordance with a preferred embodiment of the present invention. Thread pool 1004a is maintained, for example, in local memory 209 of data processing system 200 shown in FIG. 2. Thread pool 1004a maintains threads in a suspended state awaiting application requests associated with the suspended threads. Objects or threads of thread pool 1004a are interfaced to thread group 904a by adapter 1002. Thus, a thread group is maintained for every active thread pool in data processing system 200. In the current example, each thread is an instance of a resource r, and a plurality of thread pools maintained by data processing system 200 is representative of shared resources R.

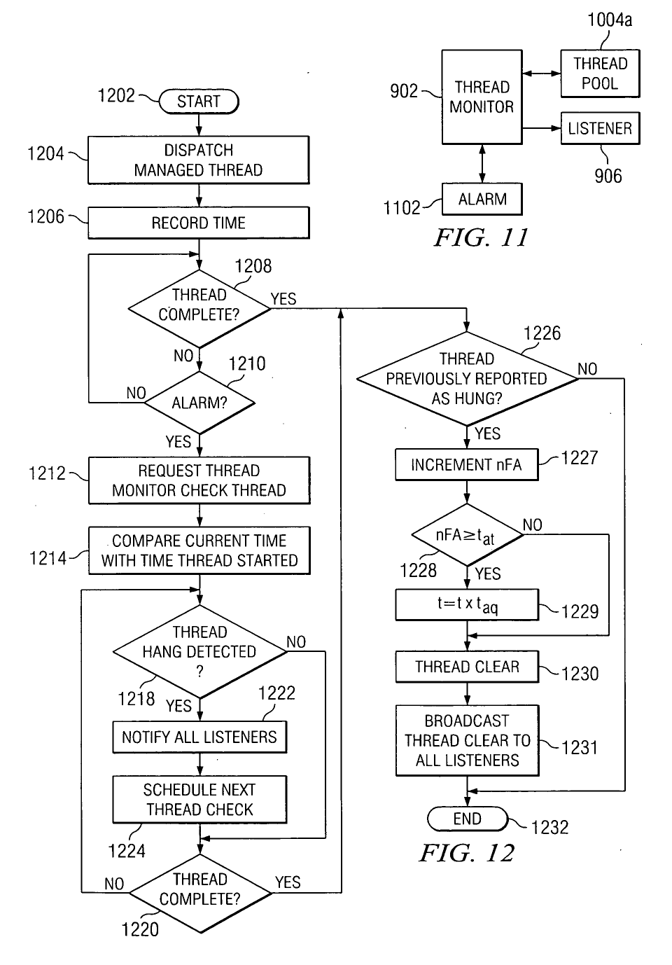

FIG. 11 is a diagrammatic illustration of component interactions of thread hang detection system 900 shown in FIG. 9 and thread pool 1004a shown in FIG. 10 implemented in accordance with a preferred embodiment of the present invention. Managed threads are dispatched for execution from thread pool 1004a. On dispatch of a thread, a current time may be noted. Alternatively, a counter or other measurement device may be invoked for monitoring the elapsed time from dispatch of the thread.

Alarm object 1102 periodically directs thread monitor 902 to check the status of all dispatched threads. Thread monitor 902 delegates thread checks to all registered thread pools via adapter 1002 of FIG. 10. Thread pool 1004a evaluates the thread execution time of all threads that have been dispatched and that have yet to complete execution. A thread hang may be identified for a dispatched thread from thread pool 1004a from which the thread was dispatched if the thread has been dispatched an amount of time that exceeds a predefined threshold. In such an event, all listeners 906 are notified of the hung thread. Thread monitor 902 then schedules the next thread check according to a predefined interval.

When a thread execution is completed, a thread clear event is issued to thread monitor 902 in the event that the thread was previously identified as a hung thread. Thread monitor 902 then broadcasts the thread clear event to listeners 906.

FIG. 12 is a flowchart of processing performed by thread hang detection system 900 in accordance with a preferred embodiment of the present invention. The resource usage violation detection routine is initialized (step 1202), for example on boot of data processing system 200 of FIG. 2, and a managed thread is dispatched (step 1204). The time of thread dispatch is recorded (step 1206). At a predefined interval, an evaluation is made to determine if execution of the thread has completed (step 1208). If the thread has completed execution after the predefined interval, the thread hang detection cycle proceeds to evaluate whether the thread was previously identified as hung (step 1226). If, however, the thread has yet to complete execution, a check is made to determine if an alarm has been issued (step 1210), and processing returns to step 1208 to evaluate the thread for completion if no alarm has been issued.

When an alarm has issued, thread monitor 902 is issued a request to check all dispatched and uncompleted threads for a possible hung thread condition (step 1212). The current time of a dispatched and uncompleted thread is compared with the dispatch time of the thread (step 1214). An evaluation of a possible hung thread is then made (step 1218). If the thread is not evaluated as hung, the routine proceeds to evaluate the thread to determine if the thread has completed execution (step 1220).

In the event that the thread is evaluate as hung at step 1218, all listeners 906 are notified (step 1222) and the next thread check is then scheduled (step 1224). After a predefined interval, an evaluation of the thread is made to determine if the execution of the thread has completed (step 1220). If the thread has not completed execution, the processing returns to step 1218 and again evaluates whether the thread is hung.

When a thread is evaluated as having completed execution at step 1220, an evaluation is made to determine if the thread was previously reported as hung (step 1226). The resource usage violation detection cycle ends (step 1232) if the thread was not previously identified as hung. In the event the thread was previously identified as a hung thread, the false alarm counter nFA is incremented (step 1227) and is subsequently compared with the adjustment threshold (1228). If the false alarm counter does not equal or exceed the adjustment threshold, a thread clear is issued (step 1230) and is broadcast to all listeners (step 1231). The resource usage violation detection cycle then ends according to step 1232. If the false alarm counter is evaluated as equaling or exceeding the adjustment threshold at step 1228, the threshold t is adjusted as a factor of threshold adjustment quantum taq and a thread clear is then issued (step 1230) and processing continues to step 1231.

In accordance with a preferred embodiment of the present invention, thread monitor 902 is implemented as computer executable instructions that are initialized with a thread pool manager at system boot. FIG. 13 is a flowchart of object initialization for implementing thread hang detection in accordance with a preferred embodiment of the present invention. A system boot is initiated (step 1302) and thread monitor 902 is initialized as part of the server (step 1304). A thread pool manager is initialized (step 1306) and subsequently the thread pool manager allocates thread pools for managing and dispatching threads. Adapter 1002 is created by the thread pool manager and is registered with thread monitor 902 as a thread group (step 1308). Other components of thread hang detection system 900 may register thread groups with thread monitor 902. Additionally, other components may register listeners with thread monitor 902 (step 1310). The server then starts the thread monitor (step 1312) and thread monitor 902 subsequently creates an alarm per a predefined interval (step 1314). At expiration of the alarm interval, all thread groups are evaluated for hung threads (step 1316), and the next alarm is then scheduled (step 1318). Operation of the thread hang detection system preferably continues until the server is shutdown (step 1320).

Thus, a shared resource monitor mechanism that detects and reports a shared resource that exhibits unexpected usage behavior during execution of a task is provided. The monitor mechanism identifies shared resource usage violations in a manner that is scalable. The shared resource usage violation detection system that provides a mechanism for identifying hung threads in a data processing system.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of identifying a shared resource usage violation in a data processing system, the method comprising the computer implemented steps of:
assigning a set of resources of a data processing system to a resource group;
defining a usage policy associated with the resource group, wherein the usage policy includes a threshold;
determining a usage state of a resource including in the resource group;
comparing the usage state of the resource included in the resource group with the threshold defined by the policy; and
determining if usage of the resource is in violation of the policy.

2. The method of claim 1, wherein the usage state is compared with the threshold at pre-defined intervals.

3. The method of claim 2, further comprising:
responsive to determining usage of the resource is in violation of the policy, incrementing a count of violations of the resource.

4. The method of claim 3, wherein the count is recorded in a record associated with the resource group.

5. The method of claim 4, wherein the resource group is one of a plurality of resource groups.

6. The method of claim 5, further comprising:
maintaining a map that stores the record, wherein each resource group has a record maintained in the map.

7. The method of claim 1, wherein the resource group includes a thread executed by a data processing system and the threshold defines a time with which the thread is executed by a processing unit.

8. The method of claim 7, further comprising:
responsive to determining that the usage of the resource is in violation of the policy, identifying the thread as hung.

9. The method of claim 8, wherein identification of the thread as hung is recorded in a record of a map that correlates the resource with the usage state.

10. The method of claim 9, further comprising the step of:
responsive to completing execution of the thread, removing the record from the map; and
providing an indication that the thread is not hung

11. The method of claim 1, wherein the step of assigning further includes:
assigning a plurality of resources to respective resource groups, wherein each resource group has an associated policy and the resources comprise respective processes executable by the data processing system.

12. The method of claim 1, further comprising:
responsive to determining a pre-defined number of violations of the policy have occurred, adjusting the threshold.

13. The method of claim 1, wherein the usage state is one of a calculated state and a measured state.

14. The method of claim 1, wherein the violation notification is conveyed to one or more entities that record the violation notification.

15. A data processing system having a plurality of shared resources, comprising:
a memory that contains a map that correlates a resource assigned to a resource group with a usage state of the resource and a shared resource monitor implemented as a set of instructions; and
a processing unit, responsive to execution of the set of instructions, that determines the usage state, reads the record of the map at pre-defined intervals, and compares the usage state with a threshold defined by a policy associated with the resource group, wherein the processing unit, responsive to the comparison of the usage state and the threshold, determines if the resource is in violation of the policy.

16. The data processing system of claim 15, wherein the map includes a record having an identifier of the resource and the usage state, wherein the record includes a counter of a number of violations of the policy associated with the resource.

17. The data processing system of claim 15, wherein the processing unit, responsive to determining the resource is in violation of the policy, provides a first notification of the violation.

18. The data processing system of claim 17, wherein the processing unit, responsive to determining that the resource is no longer in violation of the policy, provides a second notification that the first notification was false.

19. The data processing system of claim 15, wherein the processing unit records a count of a number of policy violations associated with usage of the resource and, responsive to the count exceeding a predetermined maximum threshold value, adjusts the threshold.

20. The data processing system of claim 15, wherein the map contains a plurality of records each associated with a resource each assigned to at least one of a plurality of resource groups.

21. The data processing system of claim 15, wherein the resource group includes at least one entity executable by the data processing system.

22. The data processing system of claim 15, wherein the usage state is one of a calculated state and a measured state.

23. A computer program product in a computer readable medium for identifying usage violations of shared resources in a data processing system, the computer program product comprising:
first instructions that determine a first usage state of a resource;
second instructions that correlate the resource assigned to a resource group and the first usage state of the resource;
third instructions that, responsive to reading the first instructions at a predefined interval, compare the first usage state with a threshold; and
fourth instructions that determine if the resource is in violation of a policy associated with the resource group.

24. The computer program product of claim 23, wherein the threshold is a state variable accessed by the policy.

25. The computer program product of claim 23, further comprising:
fifth instructions that, responsive to invocation by the resource, determine a second usage state at the beginning of processing of the resource and a third usage state when processing of the resource is complete.

26. The computer program product of claim 25, wherein the first usage state, the second usage state, and the third usage state are respectively implemented as methods invoked by the policy.

27. The computer program product of claim 23, further comprising:
fifth instructions, responsive to the fourth instructions determining the resource is in violation of the policy, that provide a notification of the violation.
